(19) United States
(12) Patent Application Publication
(10) Pub. No.: US 2023/0178954 A1
(43) Pub. Date: Jun. 8, 2023

(54) INTEGRATED OPTICAL AMPILIFICATION SYSTEMS

(71) Applicant: Gauss Lasers Tech (Shanghai) Co., Ltd., Shanghai (CN)

(72) Inventors: Hongyan Ren, Shanghai (CN); Ming Wu, Shanghai (CN); Shiyun Zhou, Shanghai (CN); Yuxin Leng, Shanghai (CN); Zhiwen Liu, Shanghai (CN); Jiashun Liu, Shanghai (CN); Tingxia Li, Shanghai (CN); Yiming Cai, Shanghai (CN); Tongxin Li, Shanghai (CN); Shian Zhou, Shanghai (CN)

(73) Assignee: Gauss Lasers Tech (Shanghai) Co., Ltd., Shanghai (CN)

(21) Appl. No.: 17/879,057

(22) Filed: Aug. 2, 2022

Related U.S. Application Data
(63) Continuation of application No. PCT/CN2021/136218, filed on Dec. 8, 2021.

(51) Int. Cl. H01S 3/067; H01S 3/00; H01S 3/13

(52) U.S. Cl. CPC H01S 3/06716; H01S 3/0064; H01S 3/13013

(57) ABSTRACT

An optical amplification system that includes a combiner and an active fiber. The combiner is configured to receive and combine an input signal and an excitation signal. The active fiber is configured to receive the input signal and the excitation signal from the combiner and generate an amplified input signal. The active fiber is directly coupled to the combiner.

### CROSS REFERENCE TO RELATED APPLICATION

This application is a continuation of International Application No. PCT/CN2021/136218, filed on Dec. 8, 2021, which is hereby incorporated by reference in its entirety.

### BACKGROUND

The present disclosure relates to integrated optical amplification systems. Optical amplifiers are widely used in optical communication to achieve long-distance transmission of optical signals. Doped fiber amplifiers (DFAs) are optical amplifiers that use a doped optical fiber (or active optical fiber) as a gain medium to amplify an optical signal. The optical signal to be amplified and a pump signal are multiplexed into the doped fiber, and the optical signal is then amplified through interaction with the doping ions. Doped fiber amplifiers applicable to optical amplification systems have been used to amplify optical signals to achieve wide gains in conventional wavelength ranges. In an optical amplifier, passive fibers (PFs) or transmission fibers are often directly connected to the DFA to transmit the mixed signals into and out of the DFA. The PFs are fibers for transmitting optical signals but without a gain medium for amplifying optical signals.

### SUMMARY

In one aspect, an optical amplification system includes a combiner and an active fiber. The combiner is configured to receive and combine an input signal and an excitation signal. The active fiber is configured to receive the input signal and the excitation signal from the combiner and generate an amplified input signal. The active fiber is directly coupled to the combiner.

In another aspect, an optical amplification system includes an active fiber and a combiner. The active fiber is configured to receive an input signal. The combiner is configured to receive and combine the input signal and an excitation signal to generate an amplified input signal. The combiner is directly coupled to the active fiber.

In still another aspect, an optical amplification system includes an active fiber and an isolator-combiner. The active fiber is configured to receive and amplify an initial signal to generate an amplified initial signal. The isolator-combiner is configured to combine an excitation signal and the initial signal to generate the amplified initial signal, and isolate noise in the amplified initial signal to generate an input signal.

### BRIEF DESCRIPTION OF THE DRAWINGS

The accompanying drawings, which are incorporated herein and form a part of the specification, illustrate aspects of the present disclosure and, together with the description, further serve to explain the present disclosure and to enable a person skilled in the pertinent art to make and use the present disclosure.

FIG. 1 illustrates a block diagram of a conventional optical amplification system.

FIGS. 2-8 each illustrates a block diagram of an exemplary integrated optical amplification system, according to some aspects of the present disclosure.

Aspects of the present disclosure will be described with reference to the accompanying drawings.

### DETAILED DESCRIPTION

Although specific configurations and arrangements are discussed, it should be understood that this is done for illustrative purposes only. As such, other configurations and arrangements can be used without departing from the scope of the present disclosure. Also, the present disclosure can also be employed in a variety of other applications. Functional and structural features as described in the present disclosures can be combined, adjusted, and modified with one another and in ways not specifically depicted in the drawings, such that these combinations, adjustments, and modifications are within the scope of the present discloses.

In general, terminology may be understood at least in part from usage in context. For example, the term “one or more” as used herein, depending at least in part upon context, may be used to describe any feature, structure, or characteristic in a singular sense or may be used to describe combinations of features, structures, or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

In an amplification process using a DFA, a relatively high-powered beam (e.g., an excitation beam) of light is mixed with the input signal using a coupler, e.g., a WDM coupler. The input signal and the high-powered beam must be at significantly different wavelengths. The mixed light is guided into a section of the DFA, which has a doped fiber (DF) with doping ions included in the core. This high-powered beam of light excites the doping ions to their higher-energy state. When the photons in the input signal meet the pumped doping ions, the doping ions give up some of their energy to the input signal and return to their lower-energy state. The input signal is amplified along its direction of travel. An isolator is often placed at the output to prevent reflections returning from the attached fiber.

As previously stated, during the amplification of pulsed laser, due to the higher peak value, non-linear effects can frequently occur, limiting the amplification of pulsed laser. Using thicker fibers shorter transmission distances is a conventional way to reduce nonlinear effects and increase average and single pulse energy. Also, in existing fiber laser and amplification systems, most of the functions are realized by functional devices. For example, a wavelength division multiplexer or a combiner is used for coupling pumping, an active optical fiber is used for amplification, and an optical fiber isolator is used for isolation protection, etc. There are many functional devices in the optical path, and the system can be complex. Often, functional devices can have long PFs on both ends and are often spliced at the ends. An undesirably large number of splices can cause high losses. For example, active optical fibers need to be spliced with the PFs of the isolator, causing the pulsed laser to pass a long transmission distance. This can cause nonlinear effects and limit pulse amplification.

There are many components in the optical path, and the system structure can be complex. There are often long PFs at both ends of a functional device. The long PFs can result in a long transmission distance of the pulsed laser, resulting in nonlinear effects and limitation in pulse amplification. Therefore, there is an urgent need for an integrated optical fiber amplifier or integrated device to solve the problem of non-linear effects caused by the large number of functional devices, large number of splices, high loss, and long transmission distance in the optical path. The integrated optical amplifier or integrated device can include a minimum number of splices and a minimum length of the PFs, reducing the limitation in pulse amplification.

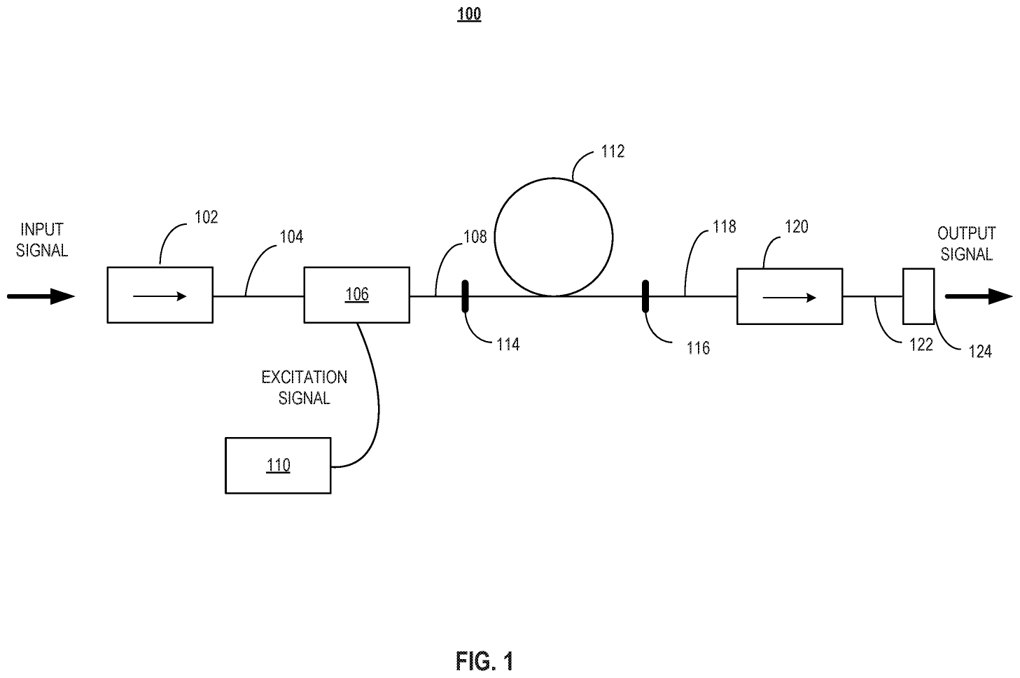

FIG. 1 illustrates a block diagram of a conventional optical amplification system 100. System 100 includes isolators 102 and 120, a WDM coupler 106, a pump laser 110, splices 114 and 116, a DF 112, PFs 104, 108, 118, and 122, and an end cap 124. An input signal is transmitted and amplified by system 100, and outputted as an output signal. Isolators 102 and 120 each allows the transmission of optical signal in single direction and block transmission of light in another direction, eliminating the unwanted back-reflected optical signal from the respective output port. WDM coupler 106 mixes the excitation signal, produced by pump laser 110, with the input signal. Splices 114 and 116 are employed to respectively join PFs 108 and 118 and DF 112. The input signal, mixed with the excitation signal, is amplified in DF 112. PFs 104 and 122 are employed to respectively transmit optical signal from isolators 102 and 120 to WDM coupler 106 and end cap 124. End cap 124 is coupled to PF 122 and is employed to output the amplified signal. End cap 124 may reduce the power density of the amplified signal, increase the laser damage threshold, protect PF 122 from potential damage, reduce beam distortion, and/or allow the amplified signal to be outputted as an output signal transmitting at a specific angle.

As shown in FIG. 1, PFs, e.g., 104, 108, 118, and 122, are employed in the transmission of the optical signal prior to and after amplification. The nonlinearity of the PFs can thus cause an inaccurate output signal and adversely impact the stability of system 100. Meanwhile, different functional parts, e.g., WDM coupler 106 and DF 112, are embedded in separate housings, affecting the integration level of system 100.

The present disclosure provides optical amplification systems with higher integration levels and reduced nonlinearity. The optical amplification systems are employed to amplify and/or transmit optical signals. Each of the optical amplification systems is an integrated device that has an input port, an output port, and a housing. An optical signal can be coupled into each optical amplification system at the input port, be amplified, and outputted at the output port. Each optical amplification system may be configured to integrate two or more functional parts, with minimal or no PFs used for the transmission of the optical signal. Instead, the optical signals can be directly coupled into functional parts by suitable optics and/or fusion. Specifically, DFs in each of the optical amplification systems are not coupled to other functional parts, e.g., combiner/isolator-combiner, by PFs, and can receive the input signal directly (e.g., without any PFs) from outside of the housing or directly (e.g., without any PFs) from another functional part. In some embodiments, the functions of two functional parts (e.g., combiner and isolator) can be integrated into a single integrated device. The optical amplification systems, which can be separately used as pre-amplifier and amplifiers, can further be integrated into the same housing to form an integrated device with higher amplification. The nonlinearity of the optical amplification systems can thus be minimized, and the integration level of the optical amplification systems can be improved. In some embodiments, the output power of the optical amplification systems ranges from about 1 W to about 1000 W.

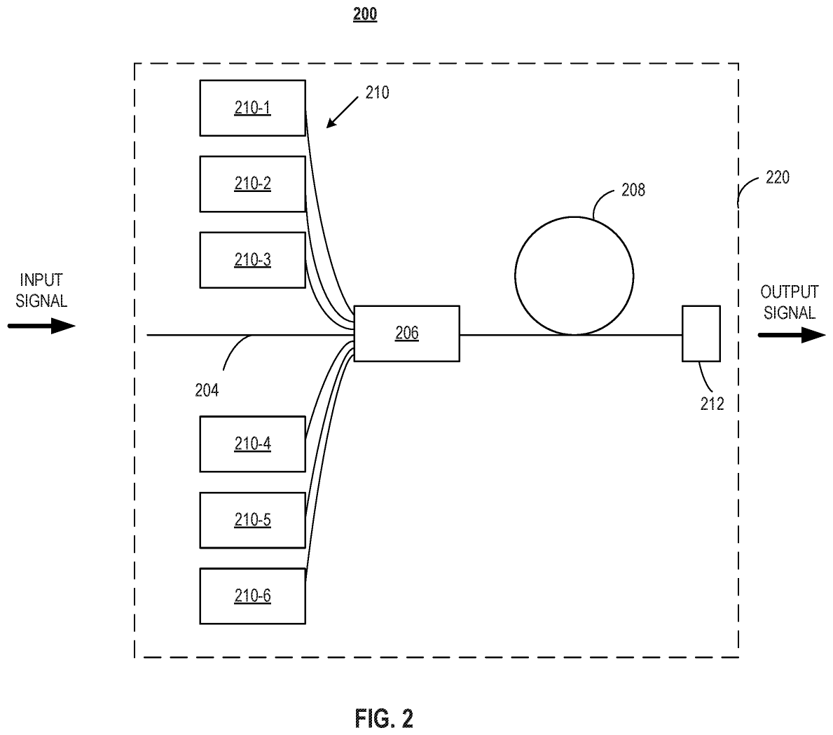

FIGS. 2-8 each illustrates an exemplary system employed for transmitting and amplifying an optical signal. For ease of illustration, similar or the same functional parts are depicted with the same numerals in different figures. FIG. 2 illustrates an exemplary system 200 for optical amplification and transmission, according to some embodiments. In some embodiments, system 200 is an integrated device that integrates the functions of light coupling and amplification. System 200 may be part of or the entirety of an amplifier. System 200 may include a PF 204, a pump laser set 210, a combiner 206, a DF 208, an end cap 212, and a housing 220. An input signal may be coupled into system 200 through PF 204, and may further be combined with an excitation signal generated by pump laser set 210 by combiner 206. The combined signal may be directly coupled into DF 208 without being transmitted by any PF and amplified by DF 208. The amplified input signal may be directly outputted by end cap 212 without being transmitted in any PF.

PF 204 may include any suitable optical fiber that can be employed for light transmission. PF 204 may include a suitable light-transmitting material, e.g., silica and/or plastic, to allow an optical signal to transmit between the two ends of PF 204. One end of PF 204 may be, e.g., coupled to a component (not shown) in which the input signal is transmitted, configured to receive the input signal. The other end of PF 204 may be directly coupled to combiner 206 through a suitable coupling means such as optical coupling and/or fusion. In some embodiments, PF 204 has a core/cladding size of 10/125 or 10/130. PF 204 may function as an input port of system 200 for receiving the input signal.

Pump laser set 210 may include at least one pump laser for providing an excitation signal for exciting the doping ions in DF 208. The excitation signal may create population inversion in DF 208, and the input signal may be amplified by stimulated emission. The wavelength of the excitation signal is desirably different from the wavelength of the input signal. Depending on the type(s) of doping ions in DF 208, the wavelength is close to the peak absorption wavelength of the doping ions. In some embodiments, pump laser set 210 includes a plurality of pump lasers. Each of the pump lasers may function as an excitation source of system 200 and may include a laser diode. The pump lasers may be high-power pump lasers. In various embodiments, each of the pump lasers provides signal of the same wavelength, e.g., 980 nm, 1480 nm, or other suitable wavelengths, to cause population inversion in DF 208. In an example, pump laser set 210 includes 2 pump lasers. In another example, pump laser set 210 includes 6 pump lasers 210-1, 210-2, 210-3 210-4, 210-5, and 210-6, as shown in FIG. 2. The signals generated by each of the pump lasers in pump laser set 210 may be coupled into an input port of combiner 206 by forward coupling, by which the excitation signal travels in the same direction as the input signal.

Combiner 206 may include a suitable combiner, e.g., a WDM coupler, that combines the input signal (transmitted in PF 204) and the excitation signal (from all pump lasers in pump laser set 210) at the input port by forward coupling. The combined signal may be transmitted directly to DF 208 that is coupled to the output port of combiner 206. Depending on the number of pump lasers in pump laser set 210, combiner 206 may be configured to receive the signals from all the pump lasers. For example, if pump laser set 210 includes two pump lasers, combiner 206 may be a (2+1)×1 pump-signal combiner; and if pump laser set 210 includes six pump lasers, combiner 206 may be a (6+1)×1 pump-signal combiner. In some embodiments, DF 208 is directly coupled to the output port of combiner 206 without any PF. The direct coupling between DF 208 and combiner 206 may include suitable optical coupling and/or fusion.

DF 208 may include any suitable active fiber that has a medium for amplifying the input signal in the combined signal. DF 208 may include silica and be doped with ions in the core structure. DF 208 may include one or more of a ytterbium (Yb)-doped fiber, an erbium (Er)-doped fiber, a holmium (Ho)-doped fiber, and a neodymium (Nd)-doped fiber. In some embodiments, DF 208 includes a Yb-doped fiber. The doping ions, e.g., Yb, Er, Ho, and/or Nd ions, may be pumped to excitation states by the excitation signal. Amplification by stimulated emission may occur at the same wavelength of the input signal when sufficient pump power is launched to DF 208, and population inversion is created between the ground state and the excitation states. The amplified input signal may then be directly transmitted to end cap 212 without any PF. The direct coupling between DF 208 and end cap 212 may include suitable optical coupling and/or fusion.

End cap 212 may include a suitable coreless device that couples to DF 208 and output the amplified input signal as an output signal that travels at a desired angle. One end of end cap 212 may have a matching diameter as DF 208 and may be spliced onto DF 208 by fusion. The amplified input signal may enter end cap 212 through an aperture and expand evenly in the homogeneous material of end cap 212. The expanded amplified input signal may exit end cap 212 through another aperture as the output signal. The diameter and/or shape of end cap 212 determines the angle of the output signal. For example, end cap 212 may include fused silica and has a stem or tapered lead-in on one end for splicing onto DF 208. In some embodiments, end cap 212 functions as the output port of system 200 for transmitting the output signal. Housing 220 may include a chip that carries all functional parts of system 200.

As shown in FIG. 2, system 200 integrates the functions of light coupling and amplification in the same housing 220, and includes fewer PFs compared to respective functional parts in a conventional optical amplification system (e.g., 100 in FIG. 1). In some embodiments, no PF is placed between combiner 206 and end cap 212, and the combined signal is transmitted from combiner 206 to DF 208 and from DF 208 to end cap 212 directly. The use of PF is thus reduced compared to a conventional optical amplification system (e.g., 100 in FIG. 1). The nonlinearity of PF can be reduced. The reduced use of PF can also result in reduced total length/space of the fibers in housing 220, allowing system 200 to be more compact.

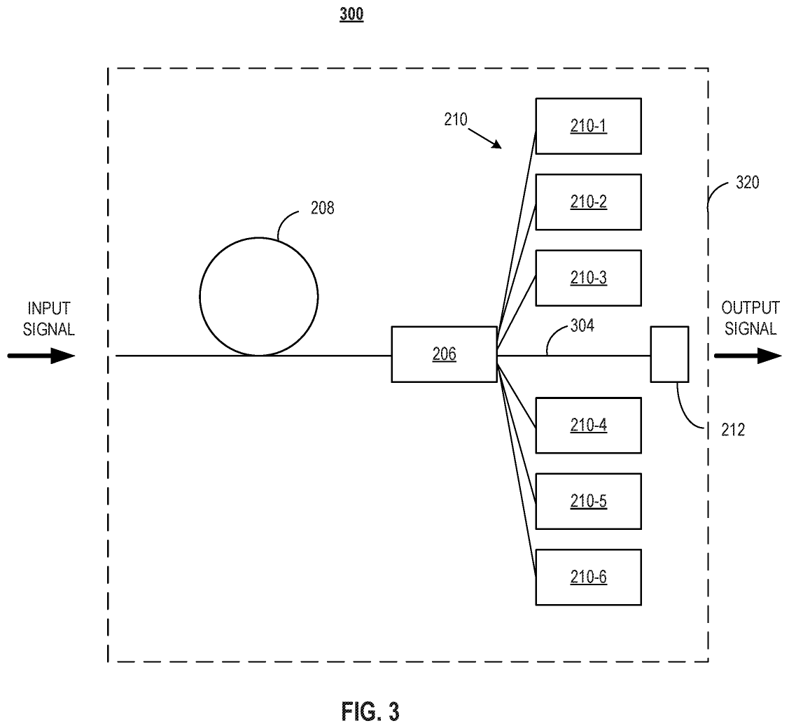

FIG. 3 illustrates an exemplary system 300 for optical amplification and transmission, according to some embodiments. In sonic embodiments, system 300 is an integrated device that integrates the functions of light coupling and amplification. System 300 may be part of or the entirety of an amplifier. System 300 may include DF 208, combiner 206, pump laser set 210, a PF 304, end cap 212, and a housing 320. As shown in FIG. 3, DF 208 may be directly coupled to combiner 206 without any PFs in between. Combiner 206 may be coupled to PF 304, which is further coupled to end cap 212. One end of DF 208 may function as the input port of system 300, and end cap 212 may function as the output portion of system 300. The input signal may be amplified in DF 208, which is pumped by pump laser set 210 through combiner 206.

As shown in FIG, 3, the input signal may be coupled into (e.g., transmitted to) system 300 directly through one end of DF 208. The other end of DF 208 may be directly coupled to the output port of combiner 206 by backward coupling, by which the excitation signal travels in the opposite way from the input signal. In some embodiments, combiner 206 may prevent the pump power (e.g., any residual excitation signal) from being outputted to PF 304. Combiner 206 may allow pump laser set 210 to pump doping ions in DF 208 from an opposite travel direction of the input signal, increasing the pumping efficiency in some embodiments. Pump laser set 210 (i.e., all the pump lasers in pump laser set 210), and one end of PF 304 may be coupled into the input port of combiner 206. The other end of PF 304 may be coupled into end cap 212. In some embodiments, pump laser set 210 includes six pump lasers, e.g., 210-1, . . . , 210-6, and combiner 206 is a (6+1)×1 pump-signal combiner. In some embodiments, pump laser set 210 includes two pump lasers, and combiner 206 is a (2+1)×1 pump-signal combiner. The coupling between DF 208 and combiner 206, between combiner 206 and pump laser set 210/PF 304, and between PF 304 and end cap 212 may each include suitable optical coupling and/or fusion. In some embodiments, PF 304 may include a single PF attached to (e.g., as part of) one of combiner 206 and end cap 212. In this case, PF 304 may be fused and/or coupled to the other one of combiner 206 and end cap 212. In some embodiments PF 304 may be formed by the coupling and/or fusion of two PFs, each attached (e.g., as part of) a respective one of combiner 206 and end cap 212. In some embodiments, PF 304 has the minimum length necessary to transmit the amplified input signal to end cap 212. In some embodiments, PF 304 has a core/cladding size of 200/220. Housing 320 may include a chip that carries all the functional parts of system 300.

As shown in FIG. 3, system 300 integrates the functions of light coupling and amplification in the same housing 320, and includes less/shorter PFs compared to respective functional parts of a conventional optical amplification system (e.g., 100 in FIG. 1). In some embodiments, no PF is placed between the input signal and combiner 206, and the input signal is amplified and transmitted directly to combiner 206. The use of PF is thus reduced compared to a conventional optical amplification system. The nonlinearity of PF can be reduced. The reduced use of PF can also result in reduced total length/space of the fibers in housing 320, allowing system 300 to be more compact.

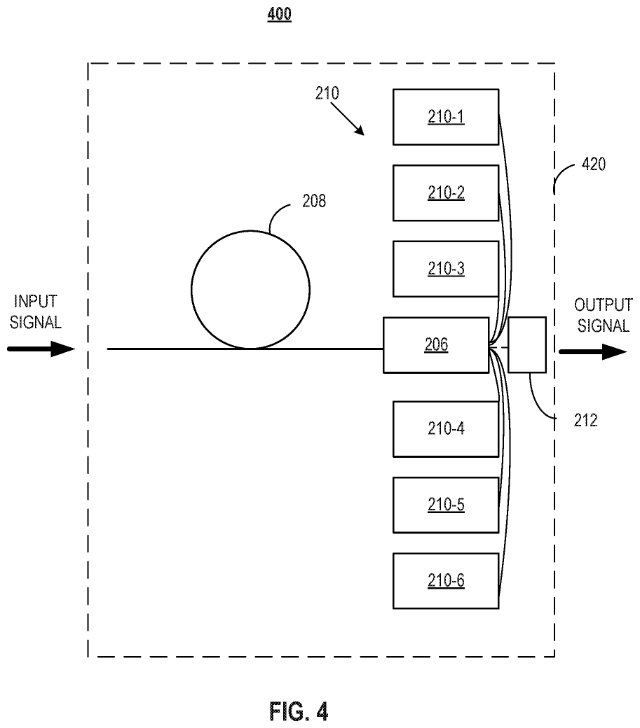

FIG. 4 illustrates an exemplary system 400 for optical amplification and transmission, according to some embodiments. In some embodiments, system 400 is an integrated device that integrates the functions of light coupling and amplification. System 400 may be part of or the entirety of an amplifier. Different from system 300, in system 400, end cap 212 is directly coupled to the input port of combiner 206 by fusion, and no PF is placed between end cap 212 and combiner 206. The amplified input signal can be transmitted from combiner 206 to end cap 212 directly. A housing 420 may include a chip that carries all the functional parts of system 400. For ease of illustration, the fusion coupling is depicted as a dashed line.

As shown in FIG. 4, system 400 further reduces the use/length of PFs compared to parts of a conventional optical amplification system (e.g., 100 in FIG. 1) of the same functions by directly fusing end cap 212 and combiner 206. The nonlinearity of PF can be reduced/eliminated in system 400. The reduced use of PF can also result in reduced total length/space of the fibers in housing 420, allowing system 400 to be more compact.

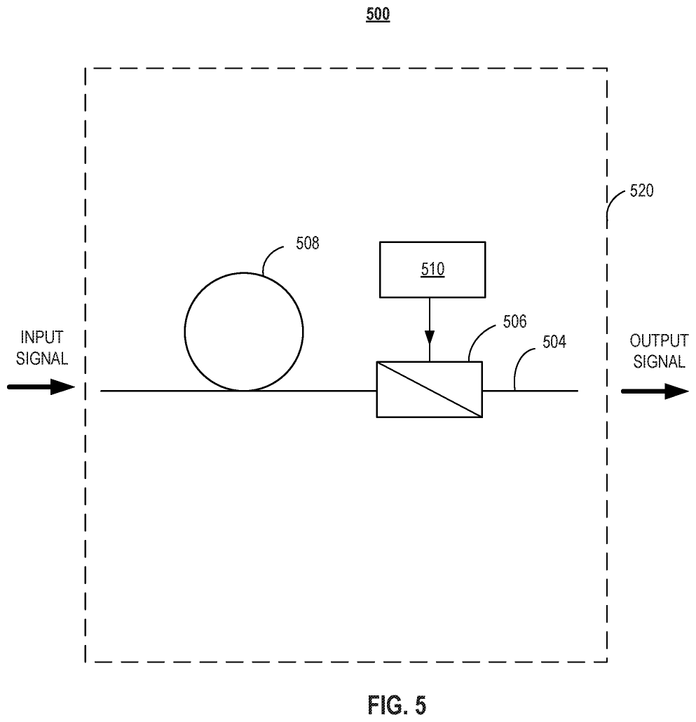

FIG. 5 illustrates an exemplary system 500 for optical pre-amplification and transmission, according to some embodiments. In some embodiments, system 500 is an integrated device that integrates the functions of pre-amplification and transmission, and can be used as a pre-amplifier. System 500 may amplify an optical signal before it is received by an amplifier (e.g., the combiner and/or the DF of the amplifier) such that the optical signal can be detectable by the amplifier. System 500 may include DF 508, an isolator-combiner 506, a pump laser set 510, a PF 504, and a housing 520. As shown in FIG. 5, one end of DF 508 may be directly coupled to isolator-combiner 506 without any PFs in between. The other end of DF 508 may function as the input port of system 500. DF 508 may be similar to DF 208, and can be the same as or different from DF 508. Isolator-combiner 506 may be coupled to one end of PF 504, of which the other end functions as the output port of system 500. The input signal may be amplified in DF 508, which is pumped by pump laser set 510 through isolator-combiner 506. In some embodiments, the input signal of system 500 includes an initial signal, and the output signal of system 500 includes an amplified initial signal that can be further amplified in an optical amplifier.

As shown in FIG. 5, the input signal may be coupled into system 500 directly through one end of DF 508. The other end of DF 508 may be directly coupled to the output port of isolator-combiner 506 by backward coupling. Pump laser set 510 (i.e., all the pump lasers in pump laser set 210) and one end of PF 504 may be coupled into the input port of isolator-combiner 506. The other end of PF 304 may output the output signal. Pump laser set 510 may include at least one pump laser. In various embodiments, pump laser set 510 can include one pump laser, two pump lasers, or six pump lasers, and the input port of isolator-combiner 506 may be coupled to all the pump lasers. The coupling between DF 508 and isolator-combiner 506, and between isolator-combiner 506 and pump laser set 510/PF 504 may each include suitable optical coupling and/or fusion. In some embodiments, PF 504 has the minimum length necessary to transmit the output signal. In some embodiments, PF 504 has a core/cladding size of 200/220. Housing 520 may include a chip that carries all the functional parts of system 500.

Isolator-combiner 506 may be an integrated device that integrates the functions of (i) coupling the excitation signal (from pump laser set 510) with the input signal, (ii) facilitating the input signal to be pumped by the excitation signal from the opposite travel direction of the input signal, and (iii) isolating the amplified input signal from noise. Isolator-combiner 506 may prevent any pump power, e.g., residual excitation signal from pumping the doping ions in DF 508, from entering PF 504. Isolator-combiner 506 may include suitable optics and/or electronics for the implementation of the functions. In some embodiments, PF 504 outputs the amplified input signal as an input signal for another optical amplification system.

As shown in FIG. 5, system 500 integrates the functions of light coupling and amplification in the same housing 520, and includes fewer/shorter PFs compared to respective functional parts of a conventional optical pre-amplification system. The nonlinearity of PF can be reduced. The reduced use of PF can also result in reduced total length/space of the fibers in housing 520, allowing system 500 to be more compact.

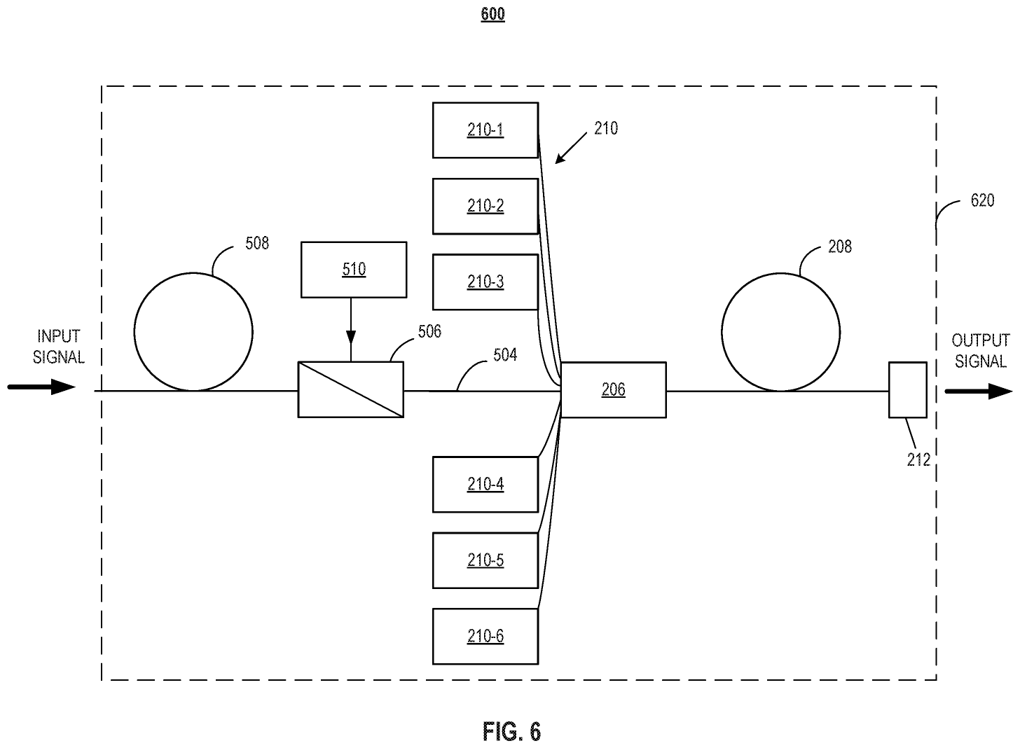

In some embodiments, system 500 can function as a pre-amplifier coupled to an amplifier (e.g., system 200, 300, or 400), for the pre-amplification of an optical signal. The optical signal may thus be amplified to a higher power using the combination of system 500 and any one of systems 200, 300, and 400. FIGS. 6, 7, and 8 each illustrates an optical amplification system that includes system 500 as a pre-amplification component and one of systems 200, 300, and 400 as an amplification component. The coupling between the pre-amplification component (e.g., system 500) and the amplification component (e.g., system 200, 300, or 400) may include a suitable optical coupling and/or fusion.

FIG. 6 illustrates a system 600 that includes a pre-amplification component and an amplification component, according to some embodiments. The pre-amplification component may include system 500, and the amplification component may include system 200. An input signal may undergo a pre-amplification in DF 508, and another amplification in DF 208. As shown in FIG. 6, one end of DF 508 may be employed as the input port of system 600, and end cap 212 may be employed as the output port of system 600. The two ends of PF 504 may respectively be coupled to the input port of isolator-combiner 506 and the input port of combiner 206 to transmit the pre-amplified input signal to DF 208 (e.g., as the input signal to system 200) to be further amplified. In some embodiments, PF 504 has the minimum length necessary for the transmission of the pre-amplified input signal. Housing 620 may include a chip that carries all the functional parts of system 600.

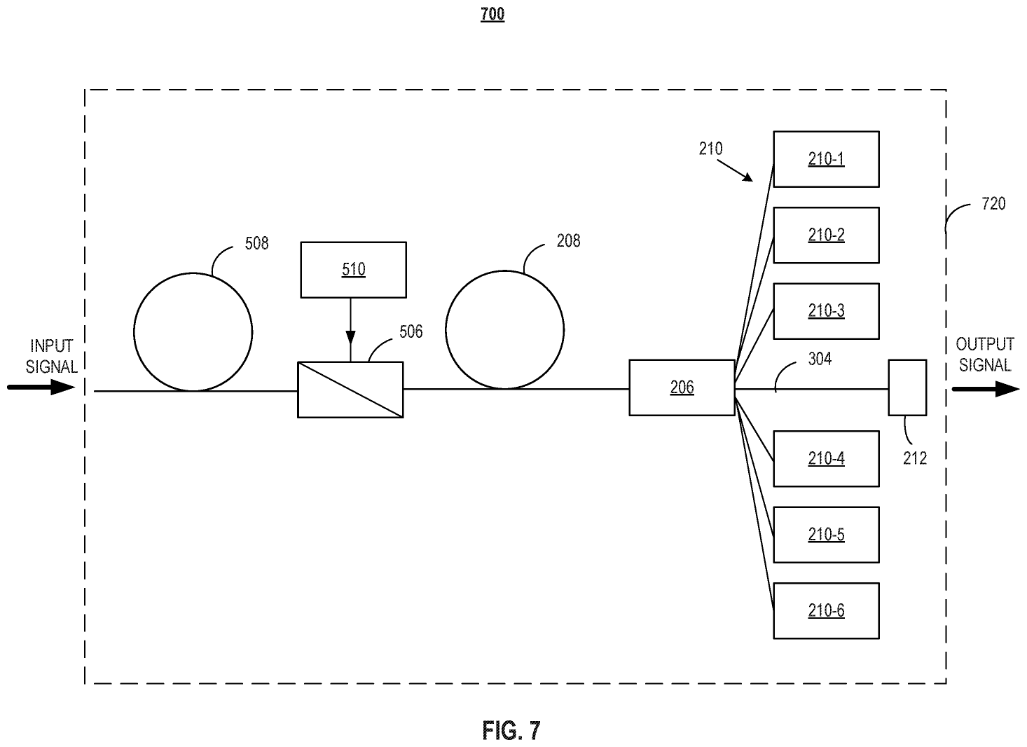

FIG. 7 illustrates a system 700 that includes a pre-amplification component and an amplification component, according to some embodiments. The pre-amplification component may include system 500, and the amplification component may include system 300. An input signal may undergo a pre-amplification in DF 508, and another amplification in DF 208. As shown in FIG. 7, one end of DF 508 may be employed as the input port of system 700, and end cap 212 may be employed as the output port of system 700. One end of DF 208 may be directly coupled to the input port of isolator-combiner 506, and the other end of DF 208 may be directly coupled to the input port of combiner 206. No PFs are placed between DF 508 and isolator-combiner 506, or between DF 208 and combiner 206. DF 208 may thus amplify the pre-amplified input signal and transmit the pre-amplified input signal to end cap 212 for output. Housing 720 may include a chip that carries all functional parts of system 700.

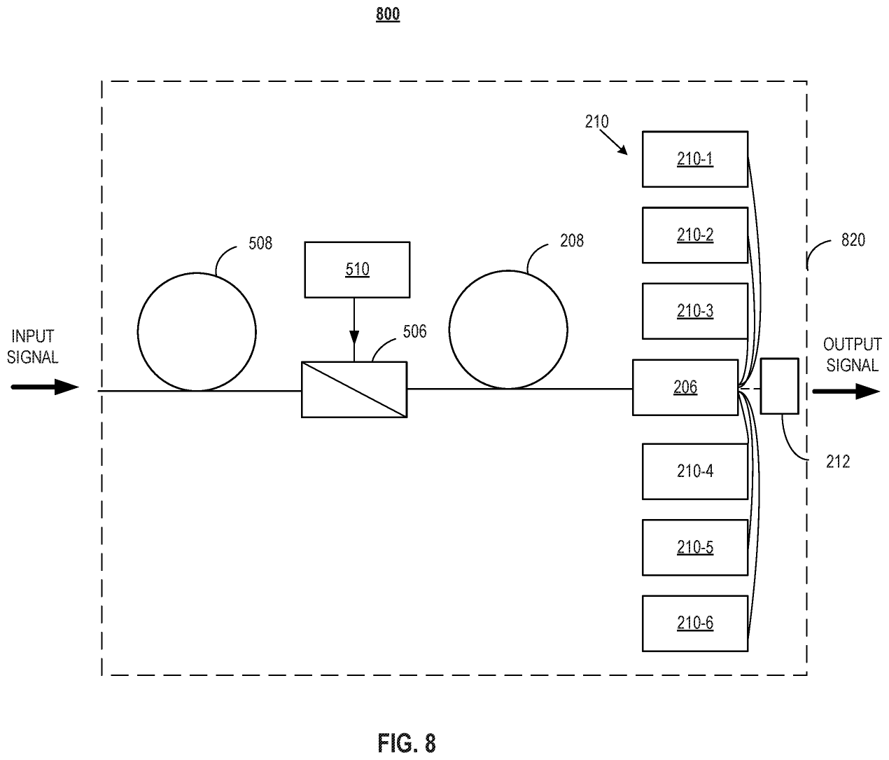

FIG. 8 illustrates a system 800 that includes a pre-amplification component and an amplification component, according to some embodiments. The pre-amplification component may include system 500, and the amplification component may include system 400. Different from system 700, end cap 212 in system 800 may be directly fused with the output port of combiner 206. The use/length of PF can be further reduced in system 800. Housing 820 may include a chip that carries all the functional parts of system 800.

As shown in FIGS. 6, 7, and 8, a pre-amplification component may be directly integrated with an amplification component in the same housing. The integration employs minimum or no PFs as the light transmission medium. The use/length of PFs in systems 600, 700, and 800 may be minimized, and the nonlinearity in these systems can be minimized accordingly. Compared to conventional optical amplification systems in which the pre-amplifier is separate from the amplifier, the integration levels of the optical amplification systems in the present disclosure are increased.

The disclosed optical amplification systems can be used for both pulse amplification (e.g., the amplification of a pulsed input signal) and continuous amplification (e.g., the amplification of a continuous input signal). In some embodiments, the DFs and PFs in the optical amplification systems of the present disclosure can be polarization-maintaining optical fibers or non-polarization-maintaining optical fibers.

Embodiments of the present disclosure provide an optical amplification system that includes a combiner, and an active fiber. The combiner is configured to receive and combine an input signal and an excitation signal. The active fiber is configured to receive the input signal and the excitation signal from the combiner and generate an amplified input signal. The active fiber is directly coupled to the combiner.

In some embodiments, the optical amplification system further includes an end cap configured to receive the amplified input signal and transmit the amplified input signal as an output signal. The active fiber is directly coupled to the end cap.

In some embodiments, the optical amplification system further includes a passive fiber coupled to the combiner to receive the input signal and transmits the input signal to the combiner.

In some embodiments, the excitation signal is coupled to the combiner by forward coupling.

In some embodiments, the excitation signal includes a plurality of signals each from a respective excitation source.

In some embodiments, the excitation signal includes the plurality of signals from six excitation sources, and the combiner includes a (6+1)×1 pump-signal combiner.

In some embodiments, the excitation signal includes the plurality of signals from two excitation sources, and the combiner includes a (2+1)×1 pump-signal combiner.

In some embodiments, the passive fiber is directly coupled to the combiner and includes at least one of a core/cladding size of 10/125 or 10/130.

In some embodiments, the active fiber includes at least one of a Yb-doped fiber, an Er-doped fiber, a Ho-doped fiber, or a Nd-doped fiber.

In some embodiments, the active fiber includes a Yb-doped fiber and includes at least one of a core/cladding size of 35/400, 30/400, 25/400, 20/400, or 40/400.

In some embodiments, the optical amplification system further includes a second active fiber configured to receive and amplify an initial signal to generate an amplified initial signal and an isolator-combiner. The isolator-combiner is configured to combine a second excitation signal with the initial signal to generate the amplified initial signal, and isolate noise in the amplified initial signal to generate the input signal.

In some embodiments, the second active fiber is directly coupled to the isolator-combiner.

In some embodiments, the second excitation signal is coupled to the isolator-combiner by backward coupling.

In some embodiments, the second excitation signal includes a plurality of signals each from a respective excitation source.

In some embodiments, the second excitation signal includes the plurality of signals from six excitation sources, and the isolator-combiner includes a (6+1)×1 pump-signal combiner.

In some embodiments, the second excitation signal includes the plurality of signals from two excitation sources, and the isolator-combiner includes a (2+1)×1 pump-signal combiner.

In some embodiments, the second active fiber includes at least one of a Yb-doped fiber, an Er-doped fiber, a Ho-doped fiber, or a Nd-doped fiber.

In some embodiments, the second active fiber includes a Yb-doped fiber and includes at least one of a core/cladding size of 35/400, 30/400, 25/400, 20/400, or 40/400.

In some embodiments, the optical amplification system further includes a housing configured to receive the input signal and transmit the output signal.

In some embodiments, the optical amplification system further includes another housing configured to receive the initial signal and transmit the output signal.

Embodiments of the present disclosure provide an optical amplification system that includes an active fiber and a combiner. The active fiber is configured to receive an input signal. The combiner is configured to receive and combine the input signal and an excitation signal to generate an amplified input signal. The combiner is directly coupled to the active fiber.

In some embodiments, the excitation signal is coupled to the combiner by backward coupling.

In some embodiments, the excitation signal includes a plurality of signals each from a respective excitation source.

In some embodiments, the excitation signal includes the plurality of signals from six excitation sources, and the combiner includes a (6+1)×1 pump-signal combiner.

In some embodiments, the excitation signal includes the plurality of signals from two excitation sources, and the combiner includes a (2+1)×1 pump-signal combiner.

In some embodiments, the active fiber includes at least one of a Yb-doped fiber, an Er-doped fiber, a Ho-doped fiber, or a Nd-doped fiber.

In some embodiments, the active fiber includes a Yb-doped fiber and includes at least one of a core/cladding size of 35/400, 30/400, 25/400, 20/400, or 40/400.

In some embodiments, the optical amplification system further includes an end cap coupled to the combiner through a passive fiber. The end cap transmits the amplified input signal as an output signal.

In some embodiments, the passive fiber includes a core/cladding size of 200/220.

In some embodiments, the passive fiber has a length of about 20 centimeters.

In some embodiments, the optical amplification system further includes an end cap fused with the combiner without a passive fiber. The end cap transmits the amplified input signal as an output signal.

In some embodiments, the combiner includes an end cap portion that transmits the amplified input signal as an output signal.

In some embodiments, the optical amplification system further includes a second active fiber configured to receive and amplify an initial signal to generate an amplified initial signal and an isolator-combiner. The isolator-combiner is configured to combine a second excitation signal with the initial signal to generate the amplified initial signal, and isolate noise in the amplified initial signal to generate the input signal.

In some embodiments, the second active fiber is directly coupled to the isolator-combiner.

In some embodiments, the second excitation signal is coupled to the isolator-combiner by backward coupling.

In some embodiments, the second excitation signal includes a plurality of signals each from a respective excitation source.

In some embodiments, the second excitation signal includes the plurality of signals from six excitation sources, and the isolator-combiner includes a (6+1)×1 pump-signal combiner.

In some embodiments, the second excitation signal includes the plurality of signals from two excitation sources, and the isolator-combiner includes a (2+1)×1 pump-signal combiner.

In some embodiments, the second active fiber includes at least one of a Yb-doped fiber, an Er-doped fiber, a Ho-doped fiber, or a Nd-doped fiber.

In some embodiments, the second active fiber includes a Yb-doped fiber and includes at least one of a core/cladding size of 35/400, 30/400, 25/400, 20/400, or 40/400.

In some embodiments, the optical amplification system further includes a housing configured to receive the input signal and transmit the output signal.

In some embodiments, the optical amplification system further includes another housing configured to receive the initial signal and transmit the output signal.

Embodiments of the present disclosure provide an optical amplification system that includes an active fiber and an isolator-combiner. The active fiber is configured to receive and amplify an initial signal to generate an amplified initial signal. The isolator-combiner is configured to combine an excitation signal and the initial signal to generate the amplified initial signal, and isolate noise in the amplified initial signal to generate an input signal.

In some embodiments, the excitation signal is coupled to the isolator-combiner by backward coupling.

In some embodiments, the excitation signal includes a plurality of signals each from a respective excitation source.

In some embodiments, the excitation signal includes the plurality of signals from six excitation sources, and the combiner includes a (6+1)×1 pump-signal combiner.

In some embodiments, the excitation signal includes the plurality of signals from two excitation sources, and the combiner includes a (2+1)×1 pump-signal combiner.

In some embodiments, the active fiber includes at least one of a Yb-doped fiber, an Er-doped fiber, a Ho-doped fiber, or a Nd-doped fiber.

In some embodiments, the active fiber includes a Yb-doped fiber and includes at least one of a core/cladding size of 35/400, 30/400, 25/400, 20/400, or 40/400.

In some embodiments, the optical amplification system further includes a combiner, a second active fiber, and an end cap. The combiner is configured to receive and combine the input signal and a second excitation signal. The second active fiber is configured to receive the input signal and the second excitation signal from the combiner and generate an amplified input signal. The end cap is configured to receive the amplified input signal and transmit amplified input signal as an output signal.

In some embodiments, the second active fiber is directly coupled to the combiner.

In some embodiments, the second active fiber is directly coupled to the end cap.

In some embodiments, the optical amplification system further includes a passive fiber coupled to the combiner and the isolator-combiner to receive the input signal and transmits the input signal to the combiner.

In some embodiments, the second excitation signal is coupled to the combiner by forward coupling.

In some embodiments, the second excitation signal includes a plurality of signals each from a respective excitation source.

In some embodiments, the second excitation signal includes the plurality of signals from six excitation sources, and the combiner includes a (6+1)×1 pump-signal combiner.

In some embodiments, the second excitation signal includes the plurality of signals from two excitation sources, and the combiner includes a (2+1)×1 pump-signal combiner.

In some embodiments, the passive fiber is directly coupled to the combiner and the iso-combiner, and includes at least one of a core/cladding size of 10/125 or 10/130.

In some embodiments, the second active fiber includes at least one of a Yb-doped fiber, an Er-doped fiber, a Ho-doped fiber, or a Nd-doped fiber.

In some embodiments, the second active fiber includes a Yb-doped fiber and includes at least one of a core/cladding size of 35/400, 30/400, 25/400, 20/400, or 40/400.

In some embodiments, the optical amplification system further includes a housing configured to receive the initial signal and transmit the input signal.

In some embodiments, the optical amplification system further includes another housing configured to receive the initial signal and transmit the output signal.

In some embodiments, the optical amplification system further includes a second active fiber and a combiner. The second active fiber is configured to receive the input signal. The combiner is configured to receive and combine the input signal and a second excitation signal to generate an amplified input signal, wherein the combiner is directly coupled to the active fiber.

In some embodiments, the second excitation signal is coupled to the combiner by backward coupling.

In some embodiments, the second excitation signal includes a plurality of signals each from a respective excitation source.

In some embodiments, the second excitation signal includes the plurality of signals from six excitation sources, and the combiner includes a (6+1)×1 pump-signal combiner.

In some embodiments, the excitation signal includes the plurality of signals from two excitation sources, and the combiner includes a (2+1)×1 pump-signal combiner.

In some embodiments, the second active fiber is directly coupled to the isolator-combiner to receive and transmit the input signal to the combiner.

In some embodiments, the second active fiber includes at least one of a Yb-doped fiber, an Er-doped fiber, a Ho-doped fiber, or a Nd-doped fiber.

In some embodiments, the second active fiber includes a Yb-doped fiber and includes at least one of a core/cladding size of 35/400, 30/400, 25/400, 20/400, or 40/400.

In some embodiments, the optical amplification system further includes an end cap coupled to the combiner through a passive fiber. The end cap transmits the amplified input signal as an output signal.

In some embodiments, the passive fiber includes a core/cladding size of 200/220.

In some embodiments, the passive fiber has a length of about 20 centimeters.

In some embodiments, the optical amplification system further includes an end cap fused with the combiner without a passive fiber. The end cap transmits the amplified input signal as an output signal.

In some embodiments, the combiner includes an end cap portion that transmits the amplified input signal as an output signal.

In some embodiments, the optical amplification system further includes a third housing configured to receive the initial signal and transmit the output signal.

The foregoing description of the specific implementations can be readily modified and/or adapted for various applications. Therefore, such adaptations and modifications are intended to be within the meaning and range of equivalents of the disclosed implementations, based on the teaching and guidance presented herein.

The breadth and scope of the present disclosure should not be limited by any of the above-described exemplary implementations, but should be defined only in accordance with the following claims and their equivalents.

What is claimed is:

1. An optical amplification system, comprising:
a combiner configured to receive and combine an input signal and an excitation signal; and
an active fiber configured to receive the input signal and the excitation signal from the combiner and generate an amplified input signal, wherein the active fiber is directly coupled to the combiner.

2. The optical amplification system of claim I, further comprising:
an end cap configured to receive the amplified input signal and transmit the amplified input signal as an output signal, wherein the active fiber is directly coupled to the end cap; and
a passive fiber coupled to the combiner to receive the input signal and transmits the input signal to the combiner.

3. The optical amplification system of claim 1, wherein the excitation signal is coupled to the combiner by forward coupling and comprises a plurality of signals each from a respective excitation source.

4. The optical amplification system of claim 3, wherein the excitation signal comprises the plurality of signals from six excitation sources, and the combiner comprises a (6+1)×1 pump-signal combiner.

5. The optical amplification system of claim 2, wherein the passive fiber is directly coupled to the combiner and comprises at least one of a core/cladding size of 10/125 or 10/130.

6. The optical amplification system of claim 1, wherein the active fiber comprises at least one of a ytterbium (Yb)-doped fiber, an erbium (Er)-doped fiber, a holmium (Ho)-doped fiber, or a neodymium (Nd)-doped fiber.

7. The optical amplification system of claim 1, further comprising:
a second active fiber configured to receive and amplify an initial signal to generate an amplified initial signal; and
an isolator-combiner configured to:
combine a second excitation signal with the initial signal to generate the amplified initial signal, and
isolate noise in the amplified initial signal to generate the input signal.

8. The optical amplification system of claim 7, wherein the second active fiber is directly coupled to the isolator-combiner.

9. An optical amplification system, comprising:
an active fiber configured to receive an input signal; and
a combiner configured to receive and combine the input signal and an excitation signal to generate an amplified input signal, wherein the combiner is directly coupled to the active fiber.

10. The optical amplification system of claim 9, wherein the excitation signal is coupled to the combiner by backward coupling and comprises a plurality of signals each from a respective excitation source.

11. The optical amplification system of claim 10, wherein the excitation signal comprises the plurality of signals from six excitation sources, and the combiner comprises a (6+1)×1 pump-signal combiner.

12. The optical amplification system of claim 10, wherein the active fiber comprises at least one of a ytterbium (Yb)-doped fiber, an erbium Er)-doped fiber, a holmium (Ho)-doped fiber, or a neodymium (Nd)-doped fiber.

13. The optical amplification system of claim 10, further comprising an end cap coupled to the combiner through a passive fiber, wherein the end cap transmits the amplified input signal as an output signal.

14. The optical amplification system of claim 10, further comprising an end cap fused with the combiner without a passive fiber, wherein the end cap transmits the amplified input signal as an output signal.

15. An optical amplification system, comprising:
an active fiber configured to receive and amplify an initial signal to generate an amplified initial signal; and
an isolator-combiner configured to:
combine an excitation signal and the initial signal to generate the amplified initial signal; and
isolate noise in the amplified initial signal to generate an input signal.

16. The optical amplification system of claim 15, wherein the excitation signal is coupled to the isolator-combiner by backward coupling.

17. The optical amplification system of claim 15, wherein the excitation signal comprises a plurality of signals each from a respective excitation source.

18. The optical amplification system of claim 17, wherein the excitation signal comprises the plurality of signals from six excitation sources, and the isolator-combiner comprises a (6+1)×1 pump-signal combiner.

19. The optical amplification system of claim 17, wherein the active fiber comprises at least one of a ytterbium (Yb)-doped fiber, an erbium (Er)-doped fiber, a holmium (Ho)-doped fiber, or a neodymium (Nd)-doped fiber.

20. The optical amplification system of claim 15, further comprising:
a combiner configured to receive and combine the input signal and a second excitation signal;
a second active fiber configured to receive the input signal and the second excitation signal from the combiner and generate an amplified input signal; and
an end cap configured to receive the amplified input signal and transmit the amplified input signal as an output signal.
